(19) United States
(12) Patent Application Publication
(10) Pub. No.: US 2006/0290158 A1
(43) Pub. Date: Dec. 28, 2006

(54) Vehicle speciality lighting system

(76) Inventor: Michael P. Cullison, Huber Heights, OH (US)

Correspondence Address: Joseph G. Nauman, 696 Renolda Woods Ct., Dayton, OH, 45429-3415, US

(21) Appl. No.: 11/475,363

(22) Filed: Jun. 27, 2006

Related U.S. Application Data
(60) Provisional application No. 60/694,211, filed on Jun. 27, 2005.

(51) Int. Cl. B62D 33/03

(52) U.S. Cl. 296/57.1

(57) ABSTRACT

An exterior display lighting system for a vehicle includes generally rectangular structure, having an outer surface and an inner surface spaced there from, so as to define an enclosure which is adapted to be attached to the vehicle, either as a modified or replacement integrated part, e.g. a tailgate or door, or as a removable accessory to the vehicle. An aperture in the outer surface extends over a substantial area of the outer surface, and a light transmitting panel mounted on said structure covering the aperture. In some instances the anel may be translucent, or it can be transparent. A lighting assemblage is supported within the structure and acts to transmit light against and through substantially the entire area of said panel. There are means for supplying and/or modulating power to parts or all of the lighting assemblage. Also provided are fittings and parts to enable conversion of a factory-supplied tailgate or door into a receptacle for the exterior display lighting system.

### RELATED APPLICATIONS

This applicatin claims priority of U.S. Provisional Application Ser. No. 60/694,211 filed 27 Jun. 2005, and applicant hereby incorporates said Provisional Application herein, in its entirety.

### BACKGROUND & FIELD OF THE INVENTION

This invention relates to specialty display lighting for vehicles, particularly for tailgates and the like for truck beds, van bodies, and hatchback vehicles. There is a need for specialty lighting displays which are for use in public service vehicles, private vehicles with similar requirements, and/or “off the road” events (meets or exhibitions), wherein the vehicles are uniquely customized and include light shows (active displays), sometimes with related audio, as might be shown at meetings or other events or gatherings, such as an auxiliary event to an automobile race.

It should be emphasized that much of this type of specialty customized lighting, and related sound effects, is ordinarily not permitted to be operated on vehicles traveling on public roads, so a feature of the invention provides the display lighting can be disabled to permit (when required) over the road legal travel.

### SUMMARY OF THE INVENTION

The basic feature is the presentation of such a lighting system embodied into a tailgate, door, or hatch cover that is fitted with a translucent screen. This is provided by either incorporating such s screen into the rear-facing exterior of a modified existing tailgate construction, or by the provision of a replacement tailgate, or an attachment lighting unit for a tailgate. Many factory provided tailgates and/or door have sufficient interior space within their structure to accommodate the features of this invention. Any of these can be powered by the electrical system of the truck or like vehicle.

Behind the translucent screen there is mounted a display assembly comprising a number of lamps. For example such an assembly may comprise incandescent, fluorescent, and/or high intensity discharge (HID) lamps capable of emitting various colors and shaped light beams. A custom designed power supply and control is provided, having the capability to switch and/or modulate electrical energy to various ones of these, either manually or with use of a programmable controller to sequence the lights on and off, or to modulate the outputs of at least some of the lights in accompaniment to music. It is thus possible to create a unique lighting show, either random or patterned. As part of the control, there is provided a confidentiality aspect to the controller which inhibits operation of this unique display system when the vehicle is in motion for any reason.

Another lighting feature which is part of this invention involves the use of large and highly visible signs identifying the type and purpose of the vehicle; for example signs can identify POLICE, BORDER PATROL, SHERIFF, M.P., etc. and can be powerfully lighted, or extinguished, as desired. These features can be of value to government and/or military service vehicles.

The various forms of the invention have in common an exterior display panel (usually translucent), which can be brightly and selectively lighted, and can be provided with appropriate opaque, or totally light-blocking, message sheets or plates. These plates are mounted in close proximity to the translucent display panel, on either side thereof, preferably on the side closer to a light source. Light emitted from a suitable source is modified in passing through the combined display panel and defines the word, term, or message(s) that will appear at the exterior of the display panel. It should be noted that the various message sheets can be easily and quickly prepared and/or modified, adding to the versatility of the invention. In addition, the other uses of the invention provide a relatively great variety of market possibilities for the invention.

### BRIEF DESCRIPTION OF THE DRAWINGS

FIGS. 1 and 2 are opposite side views of a first modified tailgate version of the invention showing the back cover in closed (FIG. 1) and open (FIG. 2) positions;

FIG. 3 illustrates the exterior translucent panel of the first modified tailgate (FIG. 1);

FIG. 4 illustrates the interior face of a fabricated tailgate (second version of invention), with the cover of the light box closed;

FIG. 5 is a perspective view of the fabricated tailgate, including the cable which provides power to and control of the light assembly;

FIG. 6 is an exploded perspective view of a third embodiment which provies for easy modification of a manufacturer provided tailgate, illustrating a lighting assembly box with its door open and positioned in alignment with an aperture formed in the interior (or back) side of the tailgate, and an opaque or translucent screen mounted in the exterior side of the tailgate;

FIG. 7 illustrates an expansible frame for retaining the translucent cover plate in the exterior wall of the third type of tailgate.

FIG. 8 is a side view of a typical factory-provided tailgate together with a fourth embodiment of the invention in the form of a hollow case which is detachably mounted to an existing tailgate on a vehicle;

FIG. 9 is a frontal view of the case shown in FIG. 8;

FIG. 10 is a top view of the rear-facing section of the case as shown in FIG. 8;

FIG. 11 is a view of the case shown in FIGS. 8-10, with the front section opened and showing the lighting assembly mounted within; and

FIG. 12 is a schematic drawing of an electrical control power supply and control device for demonstrating various effects which can be achieved with the lighting systems of the disclosed embodiments;

### DETAILED DESCRIPTION OF THE PREFERRED EMBODIMENTS

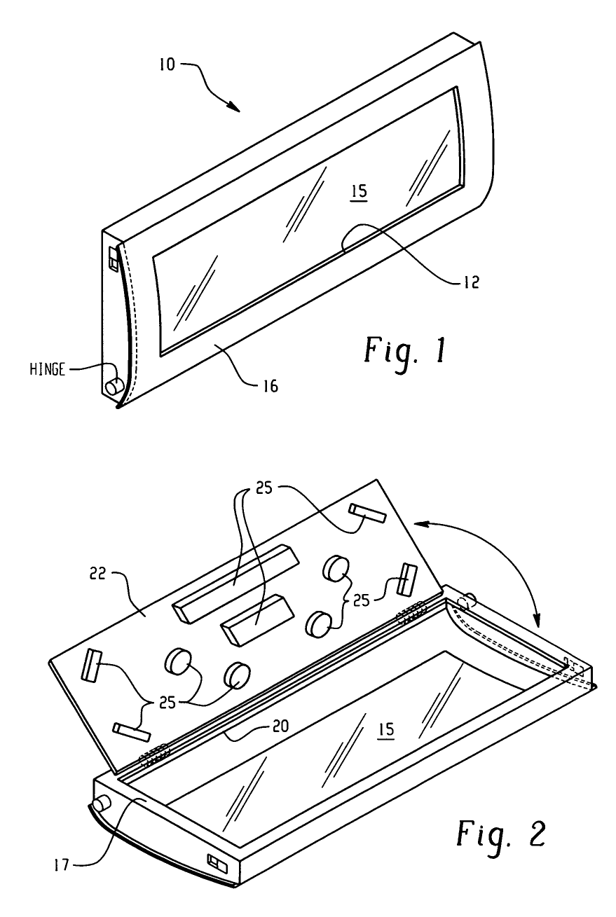

Referring to FIG. 1, this pictorial view illustrates a first embodiment of the invention in the form of a modified truck tailgate 10, (originally manufactured for a Chevrolet S-10 light duty truck). Specifically, the modified tailgate 10 is provided with a translucent panel 15 fitted to extend across an opening 12 formed in the exterior panel 16. that occupies a major area of the tailgate outer rear surface, without compromising is structural integrity. The inner (or normally inward facing) panel 17 has a large opening 18 formed therein surrounded by a frame 20 which supports a cover or door 22 hinged to frame 20 at 23, which door can be opened to gain access to the interior of the tailgate structure 10.

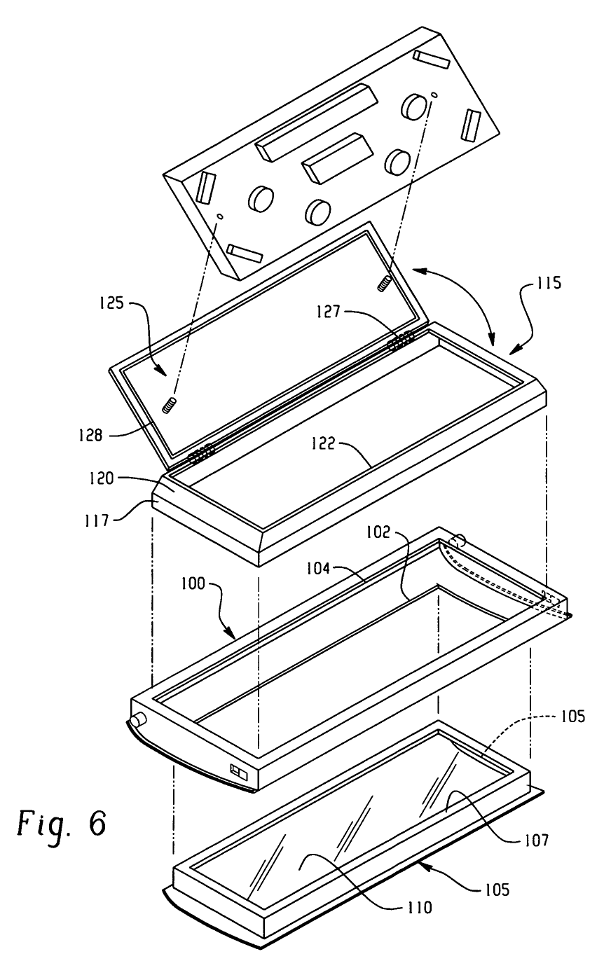

An assemblage of lights 25 is supported on the interior side of cover 22. With the cover closed, as in FIG. 5, various colors and patterns of light from this assemblage will be visible when the lights are energized, through a visually clouded area provided by the translucent, but preferably not transparent, exterior panel 15 of the tailgate (or an equivalent door or hatch). As seen in FIG. 2, the lights assemblage 25 will be fully accessible with cover 22 in its open position, allowing servicing, repair, modification and/or enhancement of the lights assemblage 25.
In an actual successful construction of this modified tailgate, the following light sources have been employed, together and/or in various combinations thereof:
Four #194 incandescent clear lamps covered with yellow lenses,
four #194 incandescent clear lamps covered with red lenses,
four #194 incandescent blue lamps fitted in open end cans,
four or more # 194 incandescent clear lamps without lenses, to flood the interior side of panel 15 with bascically non-colored light.
one ten inch blue neon lamp, and
one #1157 incandescent clear lamp covered by red lens.

Panel 15 can either provide a suitable message in large letters, either as opaque letters or signage, for a ‘negative’ appearance, e.g. dark letters surrounded by background light (usually white), or clear letters or signage, for a ‘positive’ appearance, e.g. an opaque background surrounding clear or highly translucent letters or signage

By way of example only, such signs could read POLICE, BORDER PATROL, SHERIFF, M.P., etc. and by using a negative appearance (as explained above) the 1 message could be enhanced by flashing colored lights illuminating the clear areas of panel 15. These features are applicable to all the embodiments described and illustrated in the application.

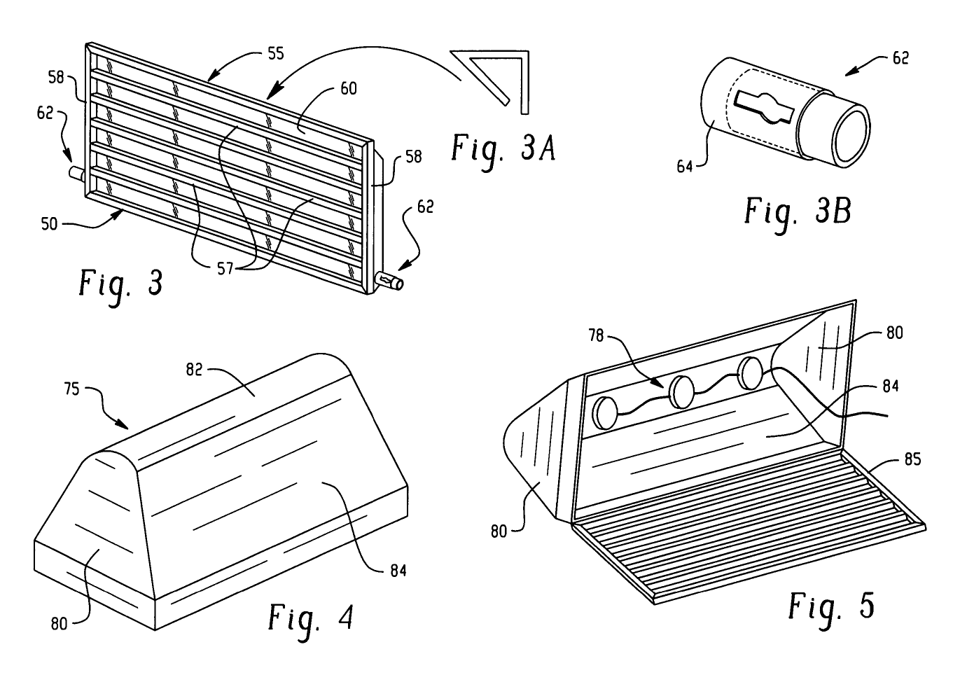

Referring to FIGS. 3-5, a second embodiment of the invention is provided in the form of a fabricated tailgate 50. This tailgate includes a body 55 made up of 10 metal (preferably steel) square tubing and including a set of transverse bars 57 and a pair of vertically arranged rods 58. Middle ones of bars 57 are optionally removable, so as to provide a central area of variable dimension. A translucent panel 60 is secured to the back side of body 55, thus defining a plurality of spaced ‘windows’ as seen in Figs. and . As noted above, removing some of the central 57 bars will result in changing the size of those “windows” to accommodate different sizes and/or shapes of messages or displays.

Pivot hinges 62 (FIG. 3B) support body 55 by attaching sockets 64 at the lower corners of body 55 to the pivots sockets of a removed tailgate. This allows body 55 to pivot between a lowered horizontal position extending outward of a vehicle bed or floor ad a vertical position extending upward across (and closing) the end of the vehicle bed or floor.

In this second embodiment, the case 75 of a light assemblage 78 comprises sides 80 of generally trapezoidal shape, a relatively narrow back panel 82 extending between sides 80, and forwardly and outwardly sloping top and bottom panels 84 which are fixed to a frame 85. Case 75 in turn is hinged to body 55 and this allows the case 75 to open for access to the lights assemblage 78 within the case.

In the fabricated tailgate 55 the lights assemblage can be generally the same combination of lights as set forth above for the first embodiment.

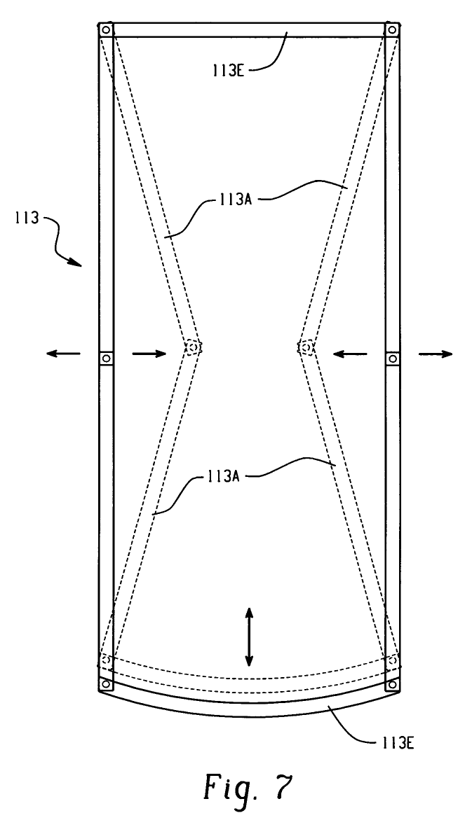

A third embodiment of this invention is, in general, similar to the first embodiment, with the addition of features that make modification and fabrication of an existing tailgate a straightforward operation that can be formed by a typical automotive body repair shop. Thus an existing tailgate 100, which is of course already fitted, and probably hinged, to a vehicle, is removed and outer and inner openings 102, 104 are cut or otherwise formed in the outwardly facing panel of the tailgate or door, and in its inwardly facing panel. An outer insert piece 105, fabricated to receive a translucent panel or “lens”, is built with a surrounding frame rim 107 that fits closely against the edges of opening 102, at the exterior of that opening, and is fastened thereto by a suitable metal adhesive or by welding. Rim 107 continues inwardly for a short distance, so as to present an internal receptor surface 108 into which the translucent panel 110 is placed. The edges of the panel can be surrounded with a suitable gasket 112 for weather tight sealing. A means is provided to retain tpanel 110 in place. Onr such means is shown in FIG. 7, in the form of a light-weight expandable and retractable frame 113 including short end pieces 113E hinged to sets of hinged side arms 113A which can be retracted to remove the frame (and panel 110), and expanded to cause frame 113 to retain panel 110 in place.

At the other or inward side of the tailgate is a second insert piece 115, constructed to fit closely into the door inner opening 104, and be secured thereto. Insert piece 115 is also provided with a rim-like lower edge 117 that is contoured and dimensioned to overlap the rim 107 of the outer insert piece 105. The adjacent and/or overlapping rims of the insert pieces preferably are not connected, so as to facilitate replacement of the translucent panel 110. As shown in FIG. 6, the second insert piece has an inwardly tapered upper edge 120 and surrounds a large access opening 122 into the door or tailgate interior. A door 125 is attached to second insert piece 125 along one of the longer edges of its opening 122 with an extended hinge 127, and a gasket 128 is provided to seal about the edge of door 12.

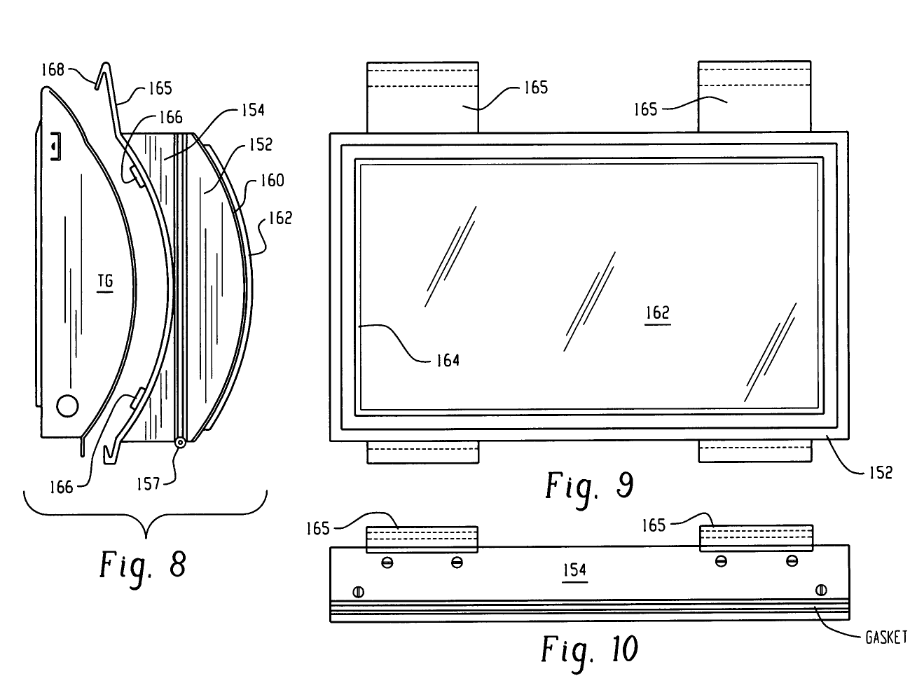

A fourth embodiment is shown in FIGS. 8-11. This construction provides for presenting the features of the invention in a separate box or case 150. The case comprises forward and rear sections 152, 154 which mate along a rectangular opening, which is defined by the rear edge 153 of section 152 and the front edge 155 of section 154. A set of hinges 157 connect those edges, at the bottom of case 150, allowing the front case section to open and close (see FIG. 11). The rear section provides support for a light assembly board 158 mounted within the front area of rear section 152. This assembly can be of the same arrangement(s) as the previously described lights assemblages.

A front aperture 160 includes a rim including a seat for translucent screen 162, which is retained in aperture 160 by a suitable molding 164 on the exterior of front section 152. A pair of mounting straps 165 are fixed to the inner side of case section 154 and extend beyond the upper and lower edges of case 150. Suitable bumpers 166 are attached to straps 165 to protect the finish of a conventional tailgate TG on a vehicle. The ends of straps 165 are provided with hooks 168 which engage about the upper and lower edges of a tailgate TG, and suitable toggles (not shown) are provided to assure a tight fir of the case 150 to tailgate TG.

In each of the illustrated embodiments, the light assemblages include the appropriate mountings and sockets for the various lamps described. It is to be understood that these are examples, and the combinations of lamps can be varied in numerous ways according to the desires of a user, and the assemblages may be is offered to end users as custom selected combinations so as to produce a desired effect.

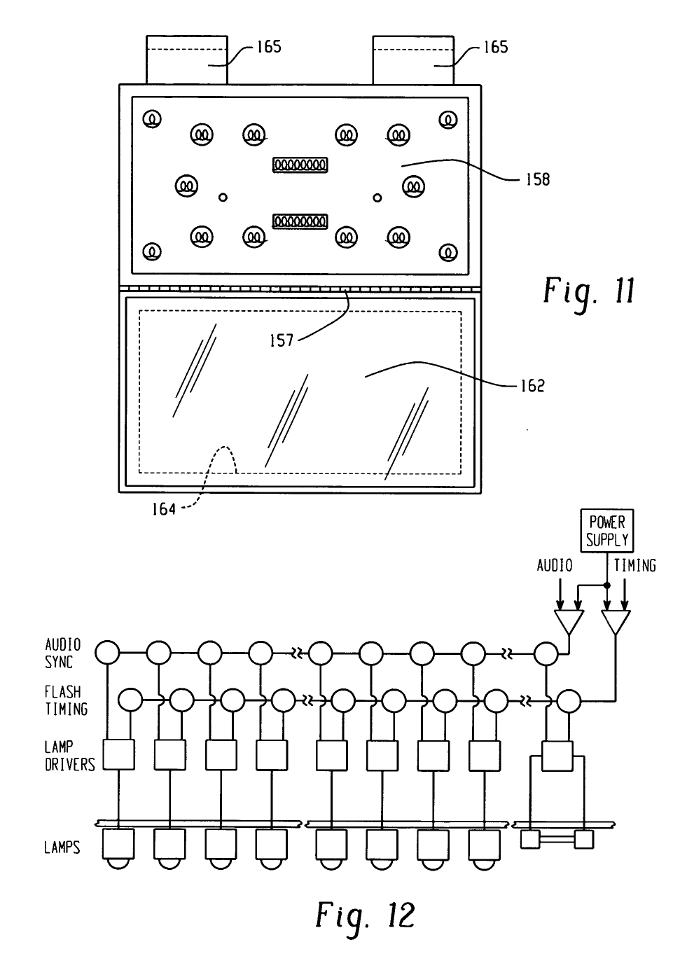

In addition, the power supply and control devices (e.g. an inverter) 30 and 130 are provided to supply the necessary power at needed voltages to the respective embodiments. Referring to FIG. 12, these control devices may optionally include frequency responsive circuits having one or more inputs from audio amplifiers or the like, together with unique outputs to special lamps in the lamp assemblages which can be adapted flash (in intensity and/or frequency) in synchronism with the audio driving signals. Details of such power supplies and control devices are known to persons of ordinary skill in those arts.

A master key-operated switch (not shown) is provided to control the operation of the power supply devices and limit their use, and hence the use of the entire light display apparatus, to instances when the vehicle is stationary. This disabling feature may be a requirement for vehicles owned by civilians and fitted with various embodiments of the invention. Those features may not be required where embodiments of the invention are fitted to government service or military vehicles.

While the forms of apparatus described and shown constitute preferred embodiments of this invention, it is to be understood that the invention is not limited to these precise forms of apparatus, and that changes may be made in them without departing from the scope of the invention.

What is claimed is:

1. An exterior display lighting system for a vehicle, comprising
generally rectangular structure having an outer surface and an inner surface spaced from said outer surface and adapted to be attached to said vehicle,
an apertue in said outer surface extending over a substantial area of said outer surface,
a light transmitting panel mounted on said structure covering said aperture,
a lighting assemblage supported within said structure and acting to transmit light against and through substantially the entire area of said panel, and
means for supplying power to said lighting assemblage.

2. An exterior display lighting system as defined in claim 1, wherein
said structure is integrated with the rear exterior of the vehicle.

3. An exterior display lighting system as defined in claim 1, wherein
said structure is a removable exterior attachment fitted to a rear exterior of the vehicle.

4. An exterior display lighting system for a vehicle as defined in claim 2, wherein said structure is a modified gate, such as a tailgate, for the vehicle.

5. An exterior display lighting system for a vehicle as defined in claim 1, wherein said lighting assemblage includes a plurality of lighting devices capable of emitting light at different spectra to alter the illumination of the light transmitting panel.

6. An exterior lighting display system for a vehicle as defined in claim 1, wherein said light transmitting panel is provided with selected areas of light blocking means so as to shape the light passed through said panel into graphic and/or textual messages.

7. An exterior lighting display system for a vehicle as defined in claim 6, wherein said light blocking means comprises darkening selected areas of said panel so as to inhibit light passage through such selected areas, thus allowing light transmitted through said panel to be shaped into a message which can be viewed at a substantial distance from the exterior of said structure.

8. An exterior lighting display system for a vehicle as defined in claim 1, wherein said structure includes movable access panels for maintenance of the system such as lighting assembly replacements and replacement of structures such as the light transmitting panel and light blocking and shaping means.

9. An exterior lighting display system for a vehicle as defined in claim 6, wherein a power supply and attenuating means is included within said structure to creat special effects lighting displays.

10. An exterior lighting display system for a vehicle as defined in claim 9, wherein and audio source is linked to said power attenuating means so as to synchronize lighting displays with audio signals such as music.

11. An exterior display lighting system for a vehicle, comprising
a tailgate structure on the vehicle provided with generally rectangular door-like structure having an outer surface and an inner surface spaced from said outer surface, said structure being secured to control and access area of said vehicle,
first and second apertures formed in said outer and inner surfaces extending over a substantial area of the exterior of said structure,
a first fitting shaped to fit within said first aperture and extend into the space between said outer and Inner surfaces,
a light transmitting panel mounted within said first fitting,
a second fitting shaped to fit within said second aperture and extend into the space between said outer and inner surfaces
a lighting assemblage supported within said second fitting and acting to transmit light against substantially the entire area of light transmitting panel, and
said first and second fittings cooperating to define a light guiding passage through means for supplying light from said lighting assemblage to the inner surface os said light transmitting panel.
